(19) United States
(12) Patent Application Publication
(10) Pub. No.: US 2025/0269586 A1
(43) Pub. Date: Aug. 28, 2025

(54) ADDITIVE MANUFACTURE RESIN

(71) Applicant: Figure, Inc., Lorton, VA (US)

(72) Inventors: Gabriel Fabricio Rodriguez, Lorton, VA (US); Jonathon Robert McDaniels, Lorton, VA (US)

(21) Appl. No.: 18/590,878

(22) Filed: Feb. 28, 2024

(51) Int. Cl. B29C 64/129; B29C 64/245; B33Y 10/00; B33Y 70/00

(52) U.S. Cl. CPC B29C 64/129; B29C 64/245; B33Y 10/00; B33Y 70/00

(57) ABSTRACT

Disclosed is a material for use as a chemical mask, and a method of applying a chemical mask to an object by first manufacturing the mask using additive manufacturing. The resin for the mask is made from a formulation that uses radical, cationic, and/or hybrid curing systems to achieve a curable resin. A mask can then be custom-designed and manufactured using the curable resin. The cured and solidified mask can then be used in chemical applications to “shield” an object from the effects of the chemical mask. The resin components can include polybutadiene with crosslinker(s) for stronger green strengths, and diluent(s) so that the composition can withstand greater temperatures when submerged in an electrochemical bath.

### TECHNICAL FIELD OF THE INVENTION

The presently disclosed embodiments relate generally to resins that are used in additive manufacturing applications. More particularly, the presently disclosed embodiments relate to resins that are additively manufactured as masks to be used in chemical bath applications.

### BACKGROUND OF THE INVENTION

Electroplating has emerged as a groundbreaking technique that has revolutionized the manufacturing industry by providing a means to enhance the functionality, appearance, and durability of various products. Electroplating involves the deposition of a thin layer of metal onto a substrate, resulting in improved corrosion resistance, increased hardness, enhanced electrical conductivity, and aesthetic appeal. Electroplating has enabled manufacturers to transform base materials into high-performance components with tailored properties, allowing for the production of products that meet stringent performance requirements. The versatility of electroplating extends across multiple sectors, including automotive, electronics, aerospace, and jewelry, among others. It has become an indispensable method for improving product quality and extending their lifespan, while also offering opportunities for cost-effective manufacturing. The continuous advancements in electroplating technologies, including the development of novel plating solutions, optimized process parameters, and efficient waste management strategies, further solidify its position as a vital tool in modern manufacturing.

Current electroplating techniques commonly rely on the use of masks to selectively control the deposition of metal coatings, preventing plating on specific areas where it is not desired. These masks serve a similar purpose as “painter's tape” by shielding designated regions of the surface. However, conventional masks are typically specialized designs that take a significant amount of time and cost to create. For example, conventional masks must be outsourced to a third-party facility and require a large amount of time and resources to create.

### SUMMARY OF THE INVENTION

The present inventors sought to overcome the disadvantages of the prior art by formulating a unique resin that could be additively manufactured as a mask and then used in chemical bath applications. The resin can be a liquid or semi-liquid photopolymer mixture that is additive manufactured with digital light processing (DLP), stereolithography, spray applications, or other forms of light-curable additive manufacturing processes. The mask is then applied to the surface of an object during a chemical bath process (e.g., electroplating) to protect the certain portions of the product from the chemical bath (e.g., the parts that are not being electrochemically plated). The mask also provides adequate resistivity to acidic conditions at elevated temperatures, and boasts high impact resistances, strengths, and other mechanical properties as compared to conventional engineering resins.

The present inventors unexpectedly discovered that polybutadiene exhibited favorable properties during electrochemical masking as a main component in the photopolymer resin used in the mask. They also found that various crosslinkers provide for stronger green strengths and improved impact properties, and that various diluents allow the overall composition to withstand greater temperatures when submerged in an electrochemical bath.

More particularly, the presently disclosed embodiments are directed to a method including providing a resin comprising one or more polybutadienes, one or more diluents, and one or more crosslinkers, printing a mask made of the resin through additive manufacturing techniques, applying the mask onto a target surface of an object, and submerging the object in a chemical bath.

The presently disclosed embodiments are further directed to a method including combining one or more polybutadienes, one or more diluents, and one or more crosslinkers into a composition, inputting data indicating a three-dimensional geometry of a mask into an additive manufacturing machine, solidifying the composition, layer by layer, using the additive manufacturing machine, thereby forming the mask, applying the mask to an object, and submerging the object in a chemical bath.

The presently disclosed embodiments are further directed to a mask for use in chemical applications. The mask includes one or more polybutadienes in a range of 20-80% by weight; one or more diluents in a range of 10-50% by weight; and one or more crosslinkers in a range of 10-50% by weight.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 illustrates the percentages of three components (adding to 100%) of a sample material, and the compatibility between those components, according to some embodiments of the present technology.

FIG. 2A is a working curve for several photoinitiator variations, according to some embodiments of the present technology.

FIG. 2B is a working curve for several sensitizer variations, according to some embodiments of the present technology.

FIG. 2C is a working curve for several inhibitor variations, according to some embodiments of the present technology.

FIG. 3A is working curve illustrating the interactions between an initiator and a UV blocker, according to some embodiments of the present technology.

FIG. 3B is a working curve illustrating the interactions between an inhibitor and a UV blocker, according to some embodiments of the present technology.

FIG. 3C is a working curve illustrating the effects of a UV blocker on two different photopackages, according to some embodiments of the present technology.

FIG. 4 illustrates an example sample with thickness measured, according to some embodiments of the present technology.

FIG. 5 illustrates solubility percentage as a function of time cured, according to some embodiments of the present technology.

FIG. 6 illustrates swell percentage as a function of time cured, according to some embodiments of the present technology.

FIG. 7 illustrates notched impact values for various curing conditions, according to some embodiments of the present technology.

FIGS. 8A and 8B illustrate a sample with surface staining only, according to some embodiments of the present technology.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” and “present inventors” is not intended to limit the scope of the claimed invention and is instead a term used to discuss exemplary embodiments of the invention for explanatory purposes only.

The presently disclosed technology relates to a resin, that is additively manufactured, and then used as a mask in a chemical bath application. This mask also obtained greater chemical resistance and toughness as compared to conventional resins which, in any event, are not used in masking applications.

The inventors sought to achieve several goals in the preparation of the present technology. First, it was desired that the printed material be able to withstand the chemical bath for long periods of time and multiple cycles, and at relatively high temperatures, such as chromic acid at 54° C. It was also desired that the printed material be able to withstand a certain level of physical impact because a certain level of durability is required in a plating shop environment. Additionally, it was desired that the cured resin masks maintain their impact resistance between multiple cycles in the chemical baths. Because of this, the present inventors tested for chemical and impact resistance after submersion in a chromic acid bath for cycles of 24 hours, and screened and developed the resin to withstand these conditions. Chromic acid is one of the most chemically abrasive and corrosive baths used for electroplating, so this was used for testing as a “worst case scenario” option.

The present inventors arrived at a material and process that showed great benefits. One benefit of the masking material is that it can quickly create both simple and complex geometries, whereas conventional masks that cannot be 3D printed require more time and labor. The disclosed mask material and method also require less post processing as compared to producing masks traditionally, and minimal lead time as the plating shops can design and print masks in-house rather than outsourcing the task to an off-site shop. In summary, the disclosed mask material and method allows the quick and relatively inexpensive production of a specialized resin part and with improved chemical and physical properties.

The present inventors conducted extensive research to arrive at the present technology. The inventors first ran a general screening of various photopolymer classes (for example, epoxy, urethane, acrylics, and vinyl). The goal was to determine chemical resistance in a chrome plating bath solution at 54° C. for 24 hours. The process involved flood curing small pucks under a UV lamp with standard photoinitiator concentrations. For example, the present inventors conducted bulk testing of 1% by weight of Omnirad® 1173 (2-hydroxy-2-methyl-1-phenylpropanone). This material was selected because it has a beneficial surface cure when exposed to 365 nm light (i.e., the flood lamp used in a conventional laboratory). This material is also anti-yellowing which allowed the present inventors to see color changes easier after chrome bath submersions. It is also in liquid form which makes it easier to mix with photopolymers of varying viscosities.

Chemical resistance was measured in two ways. The first method involved a qualitative analysis which consisted of visually inspecting the discoloration of the pucks after they were removed from the bath and dried for at least five days. The second method was a quantitative analysis in which the inventors measured the weight of the pucks before and after removing them from the bath, and then again after the pucks were left to dry for at least five days. The percentage difference in the weight of the pucks from before the bath to immediately after the bath resulted in the post-bath percentage change, and the percentage difference in the weight of the pucks before the bath to after the bath and after at least five days of drying resulted in the post-dry percentage change.

During this process, the inventors found that epoxies performed well for both resisting color change and swelling, yet the epoxy samples were harder and more brittle than their polybutadiene counterparts. Polybutadienes also showed good resistance to color change and swelling and were more flexible than their epoxy counterparts. The inventors therefore unexpectedly observed favorable properties with polybutadiene samples.

TABLE 1
Impact resistance testing

| | Formula | Impact @ |
|---|---|---|
| Material | ID | 50% CPVC |
| Bisphenol A Epoxy Methacrylate | 502 | Fail |
| Bisphenol A Epoxy Methacrylate | 502.1 | Fail |
| Bisphenol A Epoxy Methacrylate | 502.2 | Fail |
| Polyurethane Acrylate (low-mid Tg) | 503 | Pass |
| Polyurethane/Butadiene Acrylate Blend | 503.1 | Pass |
| Polyurethane Acrylate (mid Tg) | 504 | Fail |
| Polyurethane Acrylate (High Tg) | 505 | Fail |
| Aliphatic Urethane Acrylate | 506 | Fail |
| Polybutadiene Urethane Diacrylate | 507 | Fail |
| Polybutadiene Urethane Diacrylate | 507.1 | Fail |
| Polybutadiene Urethane Diacrylate | 507.2 | Pass |
| Polyurethane/Butadiene Acrylate Blend | 507.3 | Pass |
| Polybutadiene Urethane Diacrylate | 507.5 | Pass |
| Polyester Urethane Acrylate (mid Tg) | 508 | Fail |
| Polyester Urethane Acrylate (High Tg) | 509 | Fail |
| Polybutadiene Urethane Diacrylate | 513 | Pass |

As shown above, various polymers were tested for impact resistance. Those that are listed as “pass” have at least 50% the impact resistance of chlorinated polyvinyl chloride (CPVC), which is the current most common material used to machine masks currently. The purpose of the above test is to determine how the above photopolymers compared mechanically to CPVC.

TABLE 2
Exposure testing of various samples in chrome
plating solutions at process temperature
130 F. Chrome Plate, 6 hours

| | ΔMass | ΔSize | Visual |
|---|---|---|---|
| Material | (%) | (%) | Inspection |
| Material | Formulation issues, not tested | | |
| Bisphenol A Epoxy Methacrylate | 0.06 | 0.27 | No Attack |
| Polyurethane Acrylate (low-mid Tg) | 0.02 | 0.14 | No Attack |
| Polyurethane Acrylate (mid Tg) | 0.03 | 0.15 | No Attack |
| Polyurethane Acrylate (High Tg) | 0.1 | 0.21 | No Attack |
| Aliphatic Urethane Acrylate | 0 | 0.32 | Mild Attack |
| Polybutadiene Urethane Diacrylate | 0.03 | 0.11 | No Attack |
| Polyester Urethane Acrylate (mid Tg) | 1.2 | 0.37 | Heavy Attack |
| Polyester Urethane Acrylate (High Tg) | 0.07 | 0.56 | Attack |
| Polyester Acrylate | 0.68 | 0.17 | No Attack |
| Hyperbranched Polyester Acrylate | 1.37 | 3.67 | Heavy Attack |

TABLE 3
Exposure testing of various samples in a more
aggressive plating bath, alkali derust
150 F. Alkali Derust, 6 hours

| | ΔMass | ΔSize | Visual |
|---|---|---|---|
| Material | (%) | (%) | Inspection |
| Epoxy Novolak | Formulation issues, not tested | | |
| Bisphenol A Epoxy Methacrylate | 1.02 | 0.21 | Mild Attack |
| Polyurethane Acrylate (low-mid Tg) | 0.84 | 0.07 | Attack |
| Polyurethane Acrylate (mid Tg) | 0.35 | 0.21 | No Attack |
| Polyurethane Acrylate (High Tg) | 0.32 | 0.42 | No Attack |
| (Aliphatic Urethane Acrylate | 0.47 | 0.11 | Attack |
| Polybutadiene Urethane Diacrylate | 0.01 | 0.23 | No Attack |
| Polyester Urethane Acrylate (mid Tg) | 0.68 | 1.45 | Heavy Attack |
| Polyester Urethane Acrylate (High Tg) | 0.4 | 0.07 | No Attack |
| Polyester Acrylate | 0.04 | 0.03 | No Attack |
| Hyperbranched Polyester Acrylate | 3.72 | 4.64 | Heavy Attack |

As shown above, fewer candidate materials survived the more aggressive plating bath of alkali derust, which is widely considered the most aggressive plating bath used on the conventional market. Various samples achieved low changes in mass and size (volume), with successful samples also showing no attack (i.e., high chemical resistance) upon visual inspection.

The inventors then entered the second phase of development using the successful material selections. Here, the inventors developed a resin that printed well on stereolithography (SLA) and digital light processing (DLP) printers and that also exhibited high-performing mechanical and chemical properties. The inventors first screened photopolymers within the same classes to determine the more chemically resistant materials. Such photopolymers include polybutadienes, monofunctional and multifunctional acrylates/methacrylates, reactive diluents, and others.

The present inventors unexpectedly discovered that not all photopolymers within the same class have the same chemical resistance. For example, many epoxies tested unexpectedly had poor chemical resistance compared to other candidates, such as some urethane acrylates and methacrylates.

TABLE 4
Color and swell properties for urethane and epoxy samples

| Type | Swell Percentage (ΔMass) | Color (1-4) |
|---|---|---|
| Bisphenol A epoxy | −0.59 | 1 |
| Modified Epoxy | 34.95 | 4 |
| Aliphatic Epoxy | 7.75 | 3 |
| Aliphatic Epoxy | 6.43 | 3 |
| Aliphatic Urethane | 1.51 | 1 |
| Urethane | −0.74 | 2 |
| Aliphatic Urethane | 0.79 | 2 |
| Aliphatic Urethane | 1.49 | 1 |
| Aliphatic Urethane | 0.08 | 2 |

As shown above, some epoxies performed worse than urethanes, which was the opposite of what was expected.

The present inventors then tested which two components were compatible with each other from the list of components that passed the first screening test. The standard chosen ratios for testing compatibility were 20/80, 50/50, and 80/20. The inventors mixed the two components in a sample cup for 10 minutes, allowed at least 24 hours for the components to reach equilibrium, and observed layer separation or opaqueness to determine compatibility.

For those combinations where separation was difficult to observe, the inventors compared the viscosity of the mixed components with the top layer. If there was phase separation, there would be a clear viscosity difference between the two collected values. Compatibility could also be observed through nonuniform discoloration on the surface of the pucks indicating two separate phases during the flood curing of the pucks.

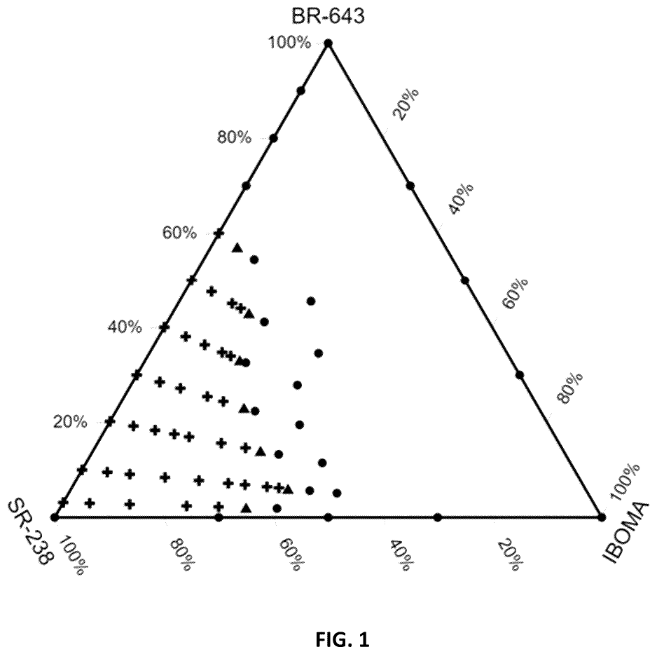

The present inventors observed that many components were at least partially compatible. They further observed that if two components are separately strongly compatible with a third component and compatible with each other without the third component, then a three-component system (the three components together) should normally be stable. When two components are partially compatible with each other, the addition of a third component which is individually compatible with both components often increases the compatibility of the overall system. For example, components 1 and 2 may not be compatible at equal ratios (50/50) but when a third component is added at about 18 percent, component A and B are now compatible at equal ratios. This is shown in FIG. 1.

FIG. 1 illustrates the percentages of three components (adding to 100%), and compatibility between those components. The components are SR-238 (1,6-hexanediol diacrylate, available from Arkema®), BR-643 (difunctional aliphatic polybutadiene urethane acrylate oligomer, available from Bomar®) and IBOMA (isobornyl methacrylate, available from Allnex®). As shown, the small circles represent compatible combinations, the triangles represent borderline compatible combinations, and the X-shaped entries represent incompatible combinations. As the IBOMA (diluent) is added, the overall ratios follow those lines towards the point that represents pure diluent. As can be seen, adding a certain amount of IBOMA helps the other two components become more compatible in the formulation, even though the other two components are not compatible by themselves. BR-643 and SR-238 are compatible above 70/30 percent respectively even by themselves but below that ratio (approximately 60/40), diluent can stabilize the formulation.

At the conclusion of the second screening step, the present inventors observed that polybutadiene is the only class of photopolymers that showed substantial chemical resistance while also having a flexible nature. Tough photopolymers tended to not perform well in the chemical test screening. Most photopolymers that performed well in the chemical screening were hard and brittle, which did not allow the formulation to be impact resistant.

TABLE 5
Swell percentages and bath behavior for various samples

| | Swell | | |
|---|---|---|---|
| | Percentage | | |
| Type | (ΔMass) | Pre-Bath Notes | Bath Notes |
| Tough | | | |
| Photopolymers | | | |
| Multifunctional | 2.91 | Hard to break by hand | Dark coloring |
| Aliphatic | 1.49 | Can't break by hand | Dark coloring |
| Urethane | | | |
| Polyether | 3.34 | Breaks by hand, | Cracked on |
| urethane | | relatively flexible | surface |
| Aliphatic | 7.06 | Can't break by hand | Became brittle/ |
| Urethane | | | flakey |
| Urethane | −3.66 | Can't break by hand | Warped puck, dark |
| Hard/Brittle | | | |
| photopolymers | | | |
| Diluent | 0.06 | Easily broken, chips | Little color change |
| | | easy | |
| Epoxy | −0.50 | Relatively easy to | Slight color change |
| | | break | |
| Diluent | −0.04 | Super easy to break | No color change |
| Diluent | 0.15 | Easy to break | No color change |
| Aliphatic | 0.75 | Broken with medium | Yellowish tint |
| epoxy | | force | |
| Polybutadienes | −0.09 | Super flexible, breaks | Yellowish tint |
| | | when bent fully | |
| | −0.70 | Flexible, doesn't break | Slightly flakey on |
| | | when folded | surface |
| | 0.15 | Flexible, resists | Light color change |
| | | folding but breaks | |
| | | after some effort | |
| | −0.13 | Very flexible, breaks | Light color change |
| | | mid fold | |
| | −1.75 | Flexible and very | Dark coloring |
| | | squishy | |

Table 5 illustrates various photopolymers tested in a chrome bath as cured pucks. The present inventors made note of the physical toughness of the pucks before and after the chrome bath as a qualitative analysis.

The third and final screening step was testing the compatibility of the photopolymers on the printing vat. The inventors found that some smaller molecular weight photopolymers can soak into the nonstick films of the vats and make them swell up, leading to failed prints and quickly deteriorating the vat film. To determine problematic photopolymers, the inventors submerged a small square of the film into the photopolymer being tested and allowed it to soak for a minimum of three days. The film was weighed before and after being submerged.

Strong green strength and low peel force are two important components to successful, consistent 3D prints. To that end, the inventors measured the viscosity, curing speed, glass transition temperature, volatility, and adhesion to vat films. The speed of curing was important because a higher speed of curing allows for quicker prints and stronger green strength of parts. Adhesion to the vat films was also important because some components had more adhesion to the non-stick films once cured, thus causing the layers to stick harder to the vat film and a higher peel force. As a result, if the layers did not have enough green strength, the prints may fail. On that note, some components accelerated grafting on the nonstick films, leading to shorter vat lives and a higher percentage of failed prints.

The inventors then tried to understand the relationship between various bulk components rather than the individual components themselves. A first example utilized two polybutadienes, a tri-functional crosslinker, a low viscosity diluent acrylate, a low viscosity diluent methacrylate, and a diluent used as a glass transition modifier to remove a variable from testing. The inventors ran a two factorial experimental design with the following variables: methacrylate/acrylate ratio, polybutadiene amount, polybutadiene ratio, and crosslinker amount. After the experiment, other formulations were tested that varied the individual components, such as the type of polybutadienes, the type of crosslinkers (including their functionality), the type of diluents, and large ratios changes, all with the approved photopolymers that passed the initial screenings. The inventors focused on chemical, mechanical, and aging/cycling properties as the results of this stage.

TABLE 6
Impact and Chrome Bath Testing of Samples

| Impact test | | | Chrome Bath test | | | | |
|---|---|---|---|---|---|---|---|
| | Impact | | (24 hr bath) | | (5+ days drying) | | |
| | Value | | Weight | | Weight | | Color |
| Formula | (J/m) | Deviation | Change % | Deviation | Change % | Deviation | Scale |
| − − − − − | 16.755 | 0.297 | 0.291 | 0.020 | 0.014 | 0.020 | 1 |
| − − − − + | 16.382 | 1.243 | 0.282 | 0.029 | 0.045 | 0.034 | 1 |
| − − − + − | 17.705 | 1.129 | 0.371 | 0.072 | −0.039 | 0.006 | 1 |
| − − − + + | 17.289 | 2.382 | 0.429 | 0.090 | −0.060 | 0.033 | 1 |
| − − + − − | 17.880 | 1.003 | −1.219 | 0.857 | −1.593 | 0.746 | 1 |
| − − + − + | 18.018 | 0.304 | −3.002 | 0.366 | −3.308 | 0.367 | 1.5/2 |
| − − + + − | 17.969 | 0.190 | 0.365 | 0.111 | 0.010 | 0.014 | 1 |
| − − + + + | 17.825 | N/A | 0.310 | 0.026 | 0.021 | 0.078 | 1 |
| − + − − − | 17.108 | 1.431 | 0.248 | 0.045 | 0.058 | 0.016 | 2 |
| − + − − + | 20.211 | 0.335 | 0.220 | N/A | 0.040 | N/A | 2 |
| − + − + − | 18.676 | 0.739 | 0.306 | 0.047 | −0.023 | 0.008 | 2 |
| − + − + + | 16.703 | 1.245 | 0.280 | 0.041 | 0.022 | 0.008 | 2 |
| − + + − − | 16.970 | 0.125 | 0.351 | 0.073 | 0.063 | 0.033 | 2 |
| − + + − + | 17.523 | 0.120 | 0.337 | 0.024 | 0.055 | 0.003 | 2 |
| − + + + − | 16.872 | 0.094 | 0.297 | 0.034 | 0.037 | 0.021 | 2 |
| − + + + + | 18.202 | 1.646 | 0.329 | 0.017 | 0.049 | 0.079 | 2 |
| 0 0 0 0 0 | 18.178 | 1.924 | 0.352 | 0.046 | 0.128 | 0.037 | 2 |
| + − − − − | 21.299 | 0.624 | 0.304 | 0.004 | 0.073 | 0.020 | 1.5/2 |
| + − − − + | 25.177 | 5.164 | 0.301 | 0.008 | 0.048 | 0.013 | 1.5/2 |
| + − − + − | 29.007 | 2.445 | 1.849 | 0.740 | 1.383 | 0.750 | 3 |
| + − − + + | 25.115 | 1.443 | 3.587 | 0.345 | 3.075 | 0.396 | 3 |
| + − + − − | 18.386 | 0.466 | 0.369 | 0.008 | 0.061 | 0.040 | 1.5/2 |
| + − + − + | 19.211 | 0.232 | 0.285 | 0.011 | −0.063 | 0.037 | 1.5/2 |
| + − + + − | 17.757 | 1.266 | 0.235 | 0.058 | −0.116 | 0.125 | 1.5/2 |
| + − + + + | 18.146 | 0.809 | 0.373 | 0.049 | 0.017 | 0.016 | 1.5/2 |
| + + − − − | 25.203 | 2.761 | 0.352 | 0.011 | 0.150 | 0.014 | 3 |
| + + − − + | 25.511 | 1.752 | 0.268 | 0.021 | 0.076 | 0.008 | 3 |
| + + − + − | 33.415 | 0.765 | 0.353 | 0.010 | 0.144 | 0.003 | 3 |
| + + − + + | 25.448 | 1.971 | 0.390 | N/A | 0.140 | N/A | 3 |
| + + + − − | 19.340 | 1.053 | 0.435 | 0.064 | 0.113 | 0.022 | 3 |
| + + + − + | 19.611 | 0.583 | 0.394 | 0.006 | 0.120 | 0.025 | 3 |
| + + + + − | 20.354 | 1.698 | 0.396 | 0.045 | 0.069 | 0.007 | 3 |
| + + + + + | 18.200 | 0.875 | 0.413 | 0.040 | 0.097 | 0.007 | 3 |
| 0 0 0 0 − | 18.032 | 1.534 | 0.285 | 0.025 | 0.053 | 0.022 | 2 |
| 0 0 0 0 + | 20.693 | N/A | 0.264 | 0.009 | 0.028 | 0.022 | 2 |

Table 6 represents the results of impact and chrome bath testing of samples. The formulations included six components: BR-640D (aliphatic polybutadiene urethane acrylate, available from Bomar®) as one polybutadiene, BR-643 as another polybutadiene, SR-351H (trimethylolpropane triacrylate, available from Arkema®) as a crosslinker, SR-506A (isobornyl acrylate available from SpecialChem S.A.®) as an acrylate diluent, SR-423 (an Isobornyl Methacrylate available from Arkema®) as a methacrylate diluent, and SR-395 (isodecyl acrylate available from Arkema®) as a glass transition modifier. The “Formula” section in the chart above includes five variables in order represented by −, 0, and + symbols as low, medium, and high. The variables shown are: (1) Total polybutadiene percentage (L:30%, M:40%, and H:50%), (2) BR-640D ratio (L:1:2, M:1:1, and H:2:1), (3) Total crosslinker percentage (L:15%, M:20%, H:25%), (4) Methacrylate diluent ratio (L:1:2, M:1:1, and H:2:1), and (5) Post curing time (L:30 minutes, M:45 minutes, and H:60 minutes). So, for example, the first “Formula” is written in shorthand above as - - - - -. This formula would therefore include the “Low” element for each of the five variables above, i.e., 30% polybutadiene percentage, 1:2 BR-640D ratio, 15% crosslinker percentage, 1:2 methacrylate diluent ratio, and 30-minute post curing time.

Diluent amount is specified as the remaining percentage after total crosslinker and polybutadiene percentage is specified. SR-395 was used in the proper amount that allowed the glass transition temperature of the diluent phase to remain the same. Proportional percentages were removed from both the methacrylate and acrylate diluents to achieve this. Glass transition temperature calculations were done using the Fox Equation, that is:

$$\frac{1}{{T}_{g}} = \frac{{w}_{1}}{{T}_{g 1}} + \frac{{w}_{2}}{{T}_{g 2}}$$

where T_{g} represents the glass transition temperature of the copolymer; w₁ and w₂ are the weight fractions of the first and second monomer, respectively; and T_{g1} and T_{g2} are the glass transition temperatures of the first and second copolymers, respectively.

The results above show that, even within the same components being used, the ratios chosen and curing time play a large role on the mechanical and chemical properties of the final parts. The inventors also found that, due to the polybutadienes, a formulation with no crosslinker has great elasticity and little hardness, even with large ratios of a hard monofunctional diluent. The rigidity and toughness of the combinations varied depending on the diluents, crosslinkers, and polybutadiene used and their ratios. Of course, the addition of mainly a monofunctional diluent would begin showing more of the diluent properties, yet this effect is much slower than when adding a crosslinker. Even with smaller amounts of the polybutadienes, the present inventors unexpectedly began seeing more significant elasticity with monofunctional diluents.

The crosslinkers served three main purposes. The first was to increase the green strength of the part so that the printed layers would be strong enough to survive the peeling forces during 3D printing. The second purpose was to increase the crosslinking of the material to decrease absorption in the baths. That is, higher functional photopolymers had less weight change in the chrome baths after a 24-hour soaking cycle. The third purpose was to adjust hardness and impact resistance, as described above.

The diluents served three main purposes. The first was to lower the viscosity of the formula, preferably below 1000 cP to facilitate printing. The second purpose was to help stabilize the semi-compatible components by “bridging” the polybutadienes with other components that were provided in the formulation. The third purpose was to adjust the glass transition temperature of the formulation above the typically low glass transition temperature of the polybutadiene composition, which can lead to morphing on the parts if the polybutadienes are submerged in baths that are significantly higher temperature than the glass transition temperature.

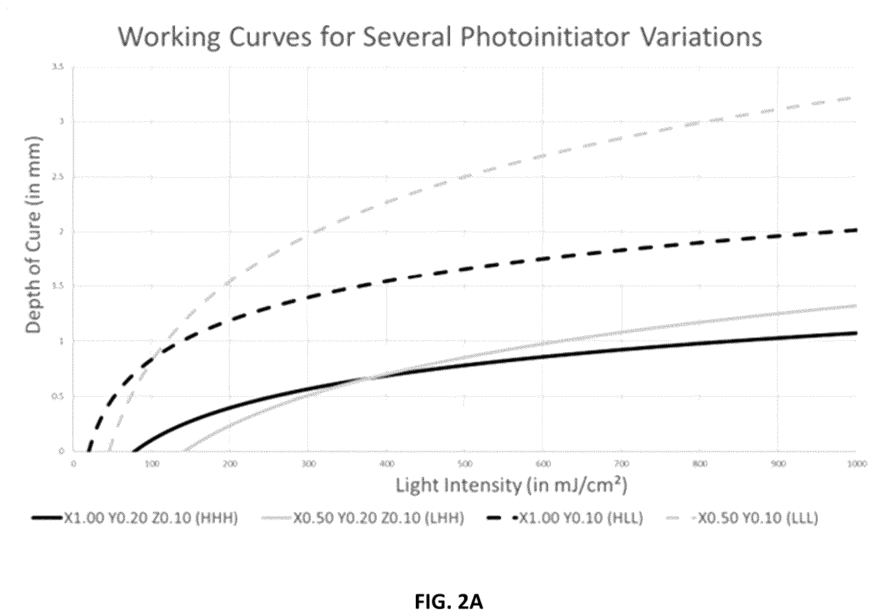

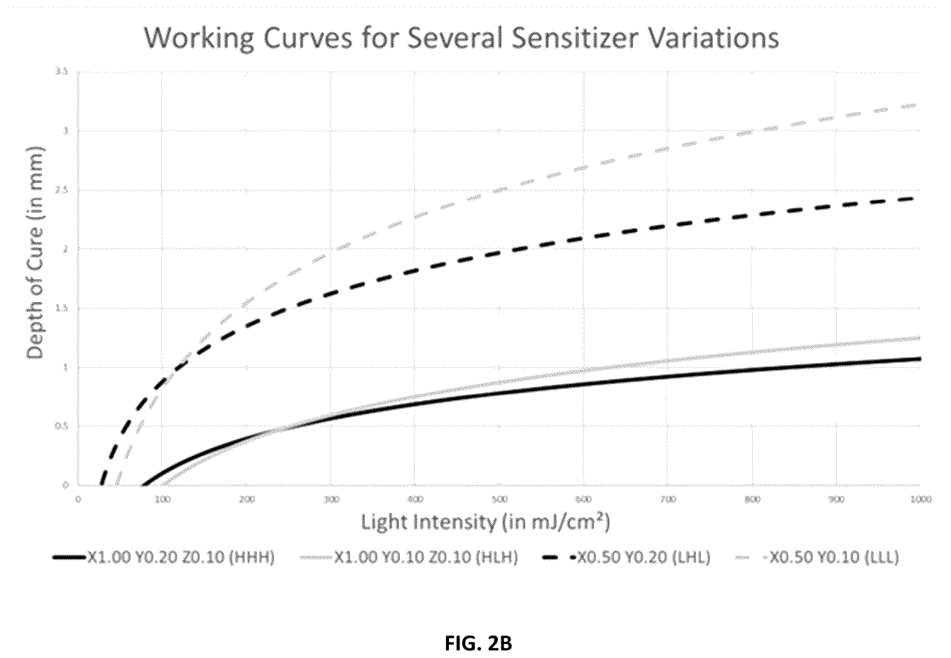

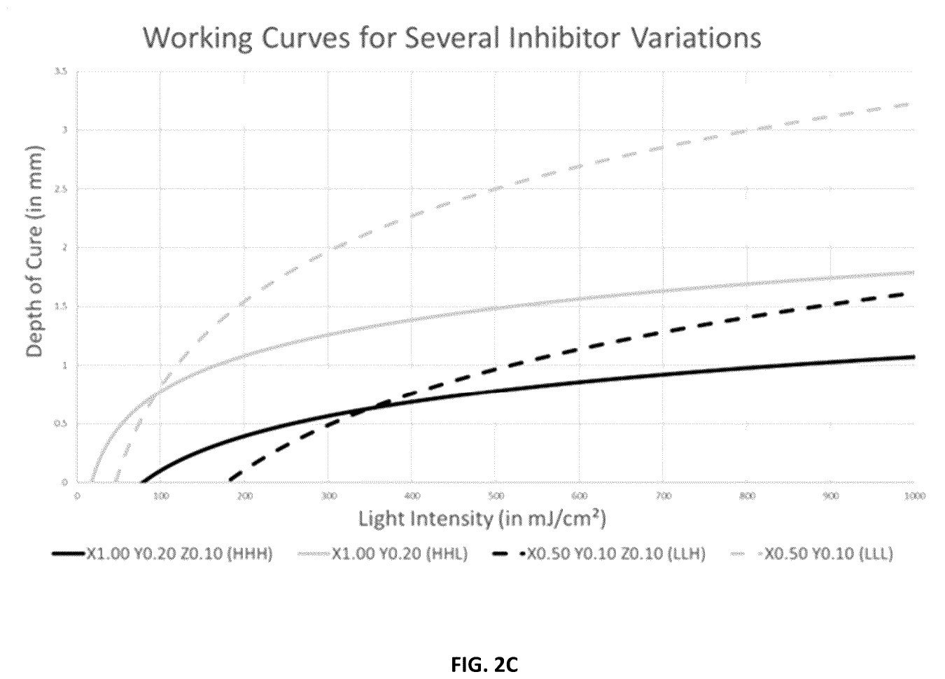

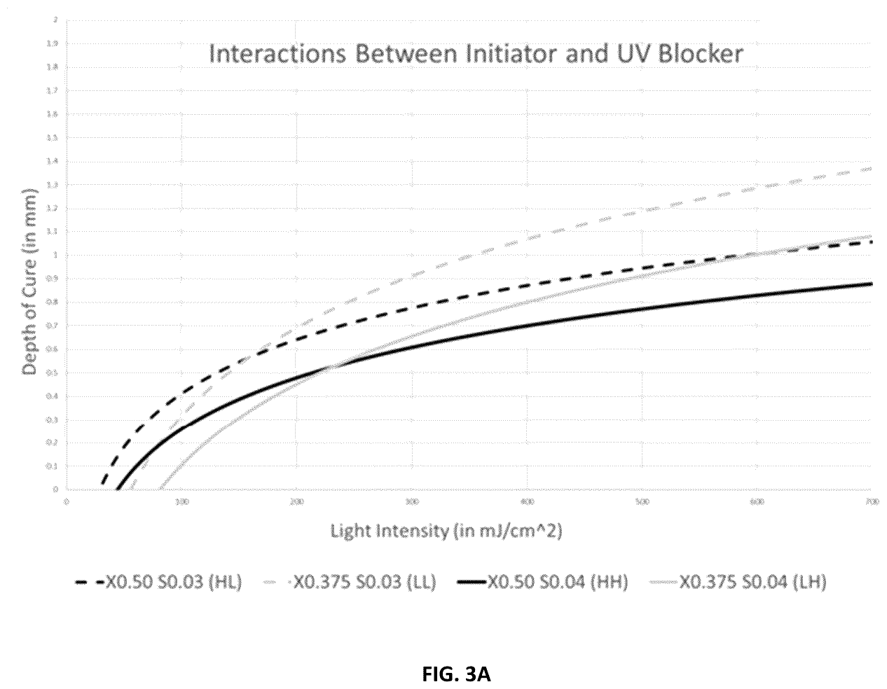

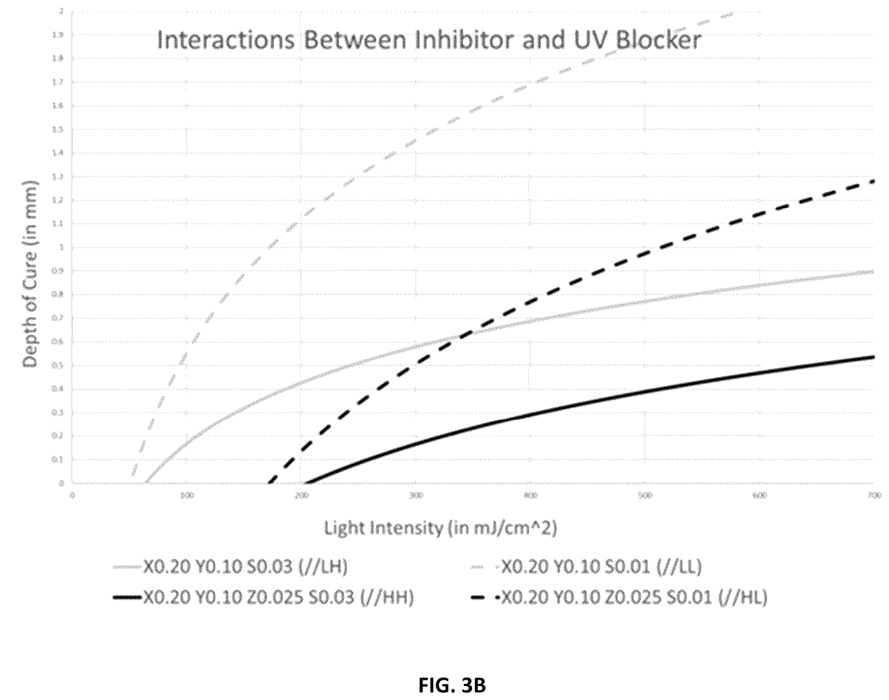

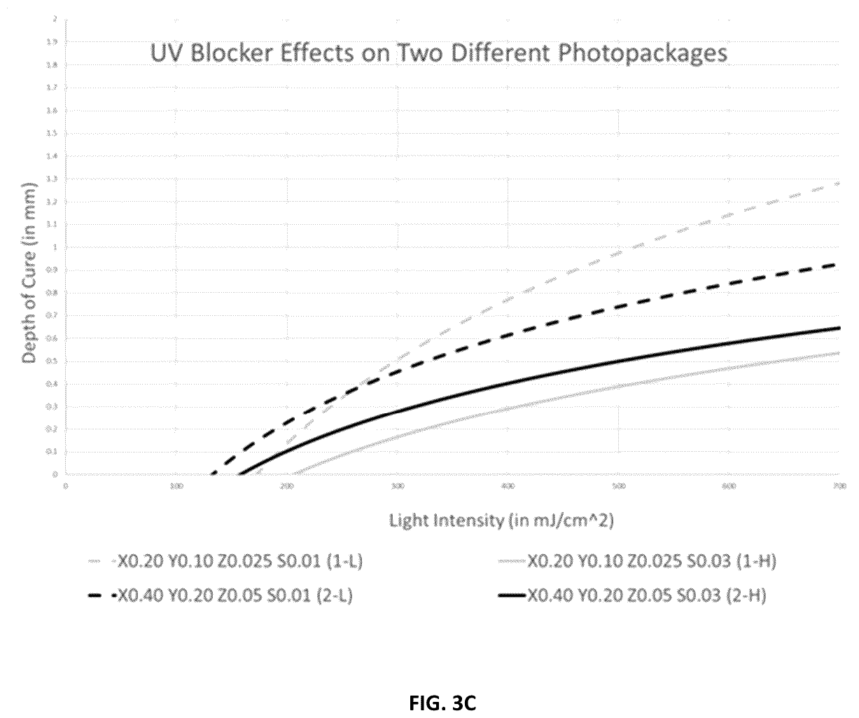

The inventors experimented with both Norrish type I and type II photoinitiators, sensitizers, both anaerobic and aerobic inhibitors, optical brighteners (UV blockers), and amine synergists to obtain the desired goals of print consistency, detail, and speed. The effects of these components can be seen in FIGS. 2A-C and FIGS. 3A-C.

FIG. 2A is a working curve for several photoinitiator variations, FIG. 2B is a working curve for several sensitizer variations, and FIG. 2C is a working curve for several inhibitor variations, according to some embodiments of the present technology. As shown for each of FIGS. 2A-C, the Y axis illustrates the depth of cure, and the X axis illustrates the light intensity. The dark black and grey lines indicate a high proportion and low proportion of the respective component (e.g., high or low photoinitiator for FIG. 2A, high or low sensitizer for FIG. 2B, and high or low inhibitor for FIG. 2C). The solid vs. dashed lines represent the high and low of the other two components (e.g., for the photoinitiator graph of FIG. 2A, solid line means high sensitizer and inhibitor, while dashed line means low sensitizer and inhibitor). The X, Y, and Z on the bottom portion of the graph is intended to describe the high or low of these components, with the photoinitiator (X), the sensitizer (Y), and inhibitor (Z) being represented alphabetically.

FIGS. 2A-C show the effect of the selected component at high and low values of the other two components. As shown in FIGS. 2A-C, the cure depth rose rapidly with light intensity for the low photoinitiator, low sensitizer, and low inhibitor sample (gray dashed line). The cure depth rose more slowly when these components were in the higher range (black solid line). Other relationships are illustrated in the figures.

FIGS. 2A-C revealed that the inhibitor increases the critical exposure energy required to cure the sample. This effect is diminished when enough photoinitiator is used to overcome thedrop. The sensitizer also plays a role in decreasing the critical exposure energy and seems to make a bigger difference when less photoinitiator is used. All three components decrease the depth of light penetration.

FIG. 3A is working curve illustrating the interactions between an initiator and a UV blocker, FIG. 3B is a working curve illustrating the interactions between an inhibitor and a UV blocker, and FIG. 3C is a working curve illustrating the effects of a UV blocker on two different photopackages, according to some embodiments of the present technology. As shown for FIGS. 3A-C, the Y axis illustrates the depth of cure, and the X axis illustrates the light intensity. For FIGS. 3A and 3B, the dark black and grey lines indicate high and low of the initiator and inhibitor, respectively, and the solid vs. dashed lines represent the high and low of the UV blocker.

FIG. 3C changes the UV blocker(S). In this case, black lines indicate one of the formulas and the solid or dashed lines indicate the high and low of the UV blocker. The grey lines indicate the formula different from the black formula.

Near the bottom of each graph, the letter X represents the initiator amount, Y represents the sensitizer amount, Z represents the inhibitor amount, and S represents the UV blocker amount. Specifically, the amounts of each of these variables are shown as concentrations of each component if they are included in a formulation in the graphs. For example, in FIG. 3C, one formula shown in the key reads “X0.40 Y0.20 Z0.05 S0.03”. This means that the formula has 0.40% by weight initiator, 0.20% by weight sensitizer, 0.05% by weight inhibitor, and 0.03% by weight UV blocker.

In each of FIGS. 3A-C, there are also parentheses next to the formulas in the key to see relationships more easily. For example, FIG. 3B has a formula that reads “X0.20 Y0.10 S0.01” and next to it in parentheses reads “(//LL)”. This graph is meant to show the relationship between only the inhibitor (Z) and UV blocker(S), yet the formulas chosen also includes initiator (X) and sensitizer (Y). The initiator and sensitizer concentrations in all the formulations in FIG. 3B are the same. What changes is only the inhibitor and UV blocker. Thus, the two forward slashes (//) represent the initiator and sensitizer that is the same for all those formulations. The H (high) and L (low) after the dashes represents the high and low values of the inhibitor and UV blockers. Thus “(//LL)” means the initiator and sensitizer represented by the forward slashes are the same in all those formulations and the inhibitor and UV blocker are both low relative to the rest of the other formulations in that graph. “(//LH)” would mean a low inhibitor amount and high UV blocker amount. As seen by the formulations in the key, the low and high of the inhibitor values is 0% (no inhibitor) and 0.025%, respectively. The low and high of the UV blocker is 0.01% and 0.03% respectively.

FIG. 3C only shows the UV blocker effect on formulations (not focusing on two component interactions). In this case the parentheses show formula 1 and formula 2 with low and high values of UV blocker (0.01% and 0.03% respectively). One formula in FIG. 3C reads “X0.20 Y0.10 Z0.025 S0.03 (1-H)”. The parentheses 1 indicates its formula is 1 and the H means it has higher amount of UV blocker. There are only two formulas with a high and low UV blocker for each one (four formulas total in this graph). What determines the “formulas” in these graphs are the amount of the rest of the components: initiator (X), sensitizer (Y), and inhibitor (Z). Looking at the two formulas in FIG. 3C, it can be seen that formula 1 has half of all three of those components compared to formula 2. The high and low of the selected component in this graph (the UV blocker S) is the highlight of the graph, indicated by L and H.

FIG. 3A is more simple, as the formulas only have initiator (X) and UV blocker(S). FIG. 3B is focused on inhibitor (Z) and UV blocker(S) but also the formulas have initiator (X) and sensitizer (Y), yet their percentages do not change for any of the formulas in that graph. FIG. 3C focuses solely on the effect of UV blocker(S) but that effect is seen in two distinct types of formulas (1 and 2). Formula(s) 1 has half of the initiator (X), sensitizer (Y) and inhibitor (Z) as formula(s) 2. Each of those “formulas” have two variations: the low UV blocker and the high UV blocker percentages.

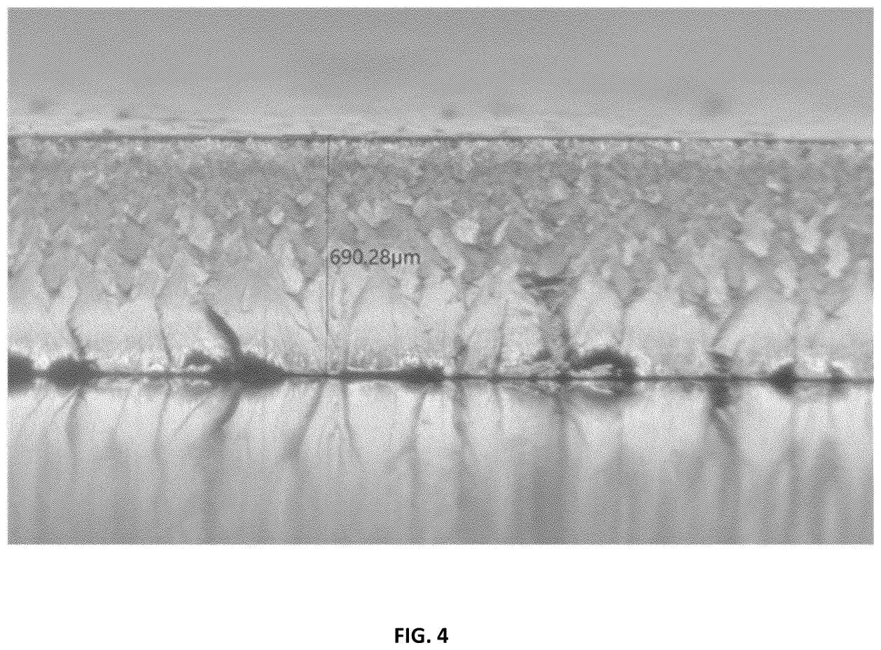

Each curve on FIGS. 3A-C show the result of printing 3 squares with varying light exposure at printer values of 100, 200, and 300 mJ/cm², which resulted in different thicknesses that helped establish a relationship between exposure and thickness for any given formula. (See FIG. 4 for an example square with corresponding thickness measurement). These working curves helped to inform what the desired printing conditions should be. Since the semi-cured squares were compressed under the forces of calipers or even low force digital micrometers, the square thicknesses were measured under a calibrated digital microscope for high precision.

The inventors then measured shelf life, pot life, and vat life for various formulations that appeared to be successful candidates. Measuring the shelf life helped determine how long the formulation would survive in a bottle. Pot life was used to determine how long the resin survived in a vat exposed to air. Measuring vat life was to test how many prints and how long before the vats were not capable of creating useable prints. The results of one of these tests can be found in Table 7 below.

TABLE 7
Vat health as a function of print quantity and size

| | | | Print | | | | |
|---|---|---|---|---|---|---|---|
| | | Print | Volume | | | | Vat |
| | Date | Quantity | (mL) | Print Time | | Success? | Health |
| | Apr. 26, 2023 | 1 | 108 | 5 h | 16 min | yes | Great |
| | Apr. 27, 2023 | 1 | 144 | 2 h | 10 min | no | Great |
| | May 2, 2023 | 1 | 100 | 5 h | 1 min | yes | Great |
| | May 3, 2023 | 1 | 130 | 5 h | 14 min | yes | Great |
| | May 4, 2023 | 1 | 255 | 9 h | 48 min | yes | Great |
| | May 5, 2023 | 1 | 339 | 10 h | 48 min | yes | Great |
| | May 9, 2023 | 1 | 339 | 10 h | 41 min | yes | Great |
| | May 18, 2023 | 1 | 105 | 5 h | 5 min | yes | Great |
| | May 19, 2023 | 1 | 143 | 5 h | 15 min | yes | Great |
| | May 23, 2023 | 1 | 143 | 5 h | 32 min | yes | Great |
| | May 25, 2023 | 1 | 339 | 11 h | 16 min | yes | Great |
| | May 30, 2023 | 1 | 154 | 7 h | 15 min | yes | Great |
| | May 31, 2023 | 1 | 29 | 1 h | 43 min | yes | Good |
| | May 31, 2023 | 20 | 234 | 10 h | 42 min | yes | Good |
| | Jun. 2, 2023 | 20 | 234 | 10 h | 31 min | yes | Good |
| | Jun. 20, 2023 | 1 | 121 | 11 h | 18 min | yes | Good |
| | Jul. 11, 2023 | 3 | 143 | 3 h | 13 min | no | Good/Fair |
| | Jul. 11, 2023 | 3 | 143 | 3 h | 12 min | no | Good/Fair |
| | Jul. 12, 2023 | 3 | 143 | 3 h | 24 min | yes | Fair |
| | Jul. 12, 2023 | 1 | 67 | 1 h | 11 min | yes | Fair |
| | Jul. 18, 2023 | 1 | 339 | 12 h | 32 min | yes | Fair |
| | Jul. 19, 2023 | 1 | 339 | 11 h | 19 min | no | Warping |
| | Jul. 20, 2023 | 2 | 72 | 2 h | 5 min | yes/no | Warped |
| Total: | ~3 months | 65 parts | 3752 mL | 141 h | 7 min | | |

Table 7 illustrates the vat health as further prints were manufactured. For pot life, shelf life, and vat life, a three liter batch of the resin was made. About 500 mL was then added to a new vat for the pot life test, and into a high density polyethylene (HDPE) brown opaque bottle. Viscosity was measured to be about 720 cP. To have a control, the inventors successfully printed a fairly large standard mask which has been successful previously.

Pot life was measured by measuring the viscosity after two months, which was considered an acceptable timeframe for the resin to sit in the vat. The viscosity increased from about 720 cP to about 752 cP, which is considered acceptable. The vat showed no visible signs of damage or swelling. The same experiment was then run on the sample print with successful results, showing that the sample resin can withstand a minimum of 2 months for pot life.

For shelf life, the viscosity of the bottled resin was tested every month for 6 months to note any changes. A small sample of resin was taken from the very top of the bottle, without agitation, for every measurement. This was to ensure that if any changes were witnessed, it could be distinguished whether the viscosity changed due to premature curing or due to phase separation. The viscosity increased from the initial 720 cP to 744 cP in the span of six months. When mixed and tested in month six, the viscosity remained the same, showing that the very small viscosity change was due to small amounts of premature curing and not phase separation. These viscosity changes are negligible and had no measurable effect in the final success of the mask print. This confirmed that the resin has a shelf life of at least six months if bottled properly and not exposed to direct sunlight.

Table 7 shows all the tests that were run on one vat before the vat was considered unusable. The amount of prints and the lifetime of the vat was based on what types of parts were printed, how often the vat was used, how big the prints were, print orientation, the number of print failures, and many other factors. Accordingly, a specific vat life could not be determined with precision. Table 7 demonstrates that the vat should be capable of printing many parts before it becomes unusable.

The inventors then determined a favorable post curing time by experimentally curing thin one-layer squares with various post curing times. To determine the extent of crosslinking after curing, submersion in acetone was used to remove any uncured resin material and any small polymer chains. To do this, the cured squares were weighed and then submerged individually in pure acetone for at least three days to allow full saturation. The squares were then removed and immediately weighed, then weighed again after being dried for at least five days, or until they stopped changing weight. The swell percentage and soluble percentage were then determined based on the following calculations:

$$\begin{matrix}MSG = MSG + WP - MWP \\ MPX = MPX + WP - MWP \\ MPS = MP 0 - MPX \\ Mw = MSG + MPX \\ Sw = Mw / MPX \\ So = MPS / MP 0 \\ SoP = So \times 100 \\ SwP = Sw \times 100\end{matrix}$$

Where MWP is the weight weighing pan; MPO is the initial weight of polymer; MSG+WP is the weight of the solvent swollen gelled material and weighing pan; MSG is the weight of the solvent swollen gelled material; MPX+WP is the weight of the dried insoluble polymer and weighing pan; MPX is the dry weight of the insoluble polymer; MPS is the weight of soluble polymer; Mw is the weight of swelling; Sw is the swell fraction; So is the soluble fraction; SoP is the soluble percentage; and SwP is the swell percentage.

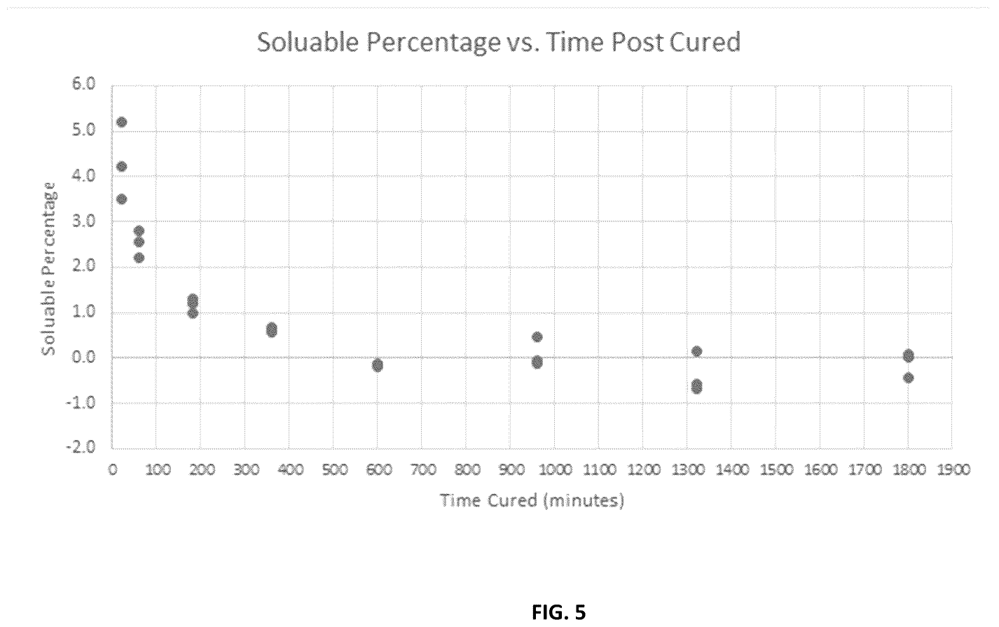

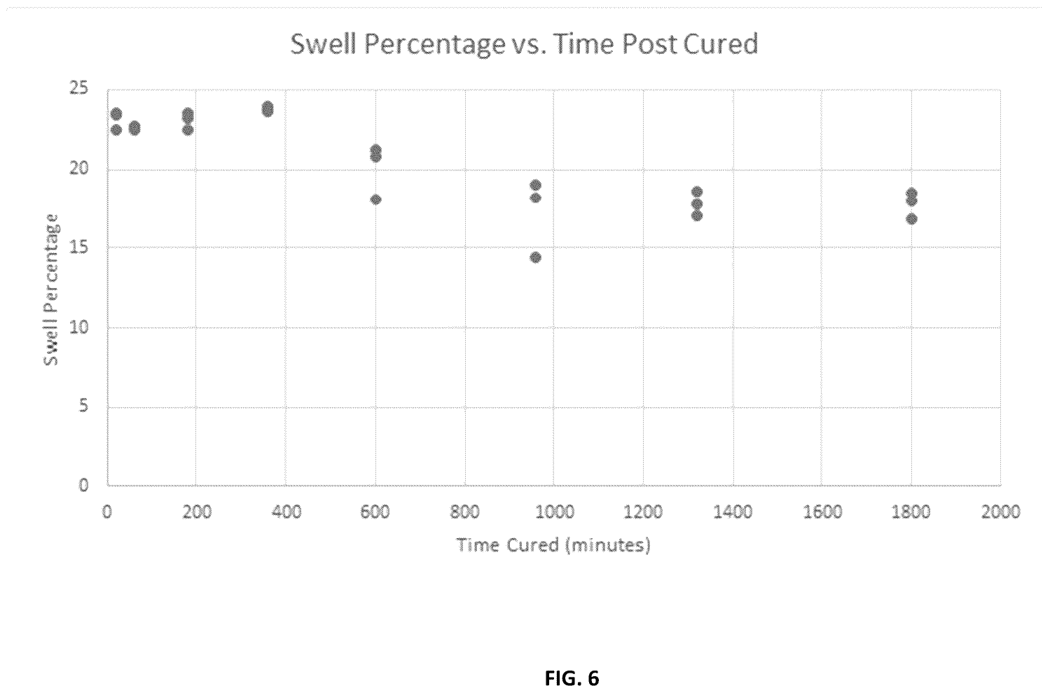

Swell percentage is typically indicative of the level of crosslinking while soluble percentage represents the total amount of polymer chains that were not large enough or crosslinked enough to remain in the matrix when submerged in acetone. These values are plotted in FIGS. 5 and 6.

The conclusion from this experiment was that at a set temperature, there will be a favorable minimum curing time that will lead to a favorable crosslinking to decrease the soluble and swell percentage for a given bulk formulation. This was helpful in creating a chemically resistant material. That is, the inventors theorized that minimizing the swell percentage and soluble percentage should lead to less liquid uptake and more chemical resistance. In this case, they determined a favorable post curing time to be 16 hours, but depending on the washing steps and other factors, this time could change.

However, further tests unexpectedly revealed that overcuring was not only unnecessary but could be detrimental to the chemical resistance. The inventors tested the notched impact resistance and weight change of several Izod impact pieces before and after a 24 hour chrome bath exposure at 54° C. A variety of curing conditions were tested that varied curing time and curing temperature: 1) 960 minutes at 80° C.; 2) 360 minutes at 80° C.; 3) 120 minutes at 80° C.; 4) 120 minutes at 60° C.; and 5) 60 minutes at 60° C. Six parts were tested for each condition before and after chemical baths (12 parts for each condition). For the parts tested in the chemical bath, weights were taken before the bath, immediately after coming out of the bath, and after five days of full air drying. Impact testing for both the chemically tested parts and the clean parts were all run on the same day (after the five-day drying period). Surprisingly, the parts cured for only 60 minutes at 60° C. outperformed the parts cured for 960 minutes at 80° C. in both weight changes before and after bath, as well as in their ability to maintain an unchanged impact resistance. The inventors theorized that overexposure to UV light may be leading to polymer degradation that would then weaken the resin's ability to withstand the harsh bath conditions. Due to the strong hydrophobic nature of the resin, the aqueous bath was unable to meaningfully penetrate further than the surface of the part. Yet, if the surface becomes degraded and attacked, it is possible that an increase in porosity would allow for the aqueous bath to penetrate further and do more damage.

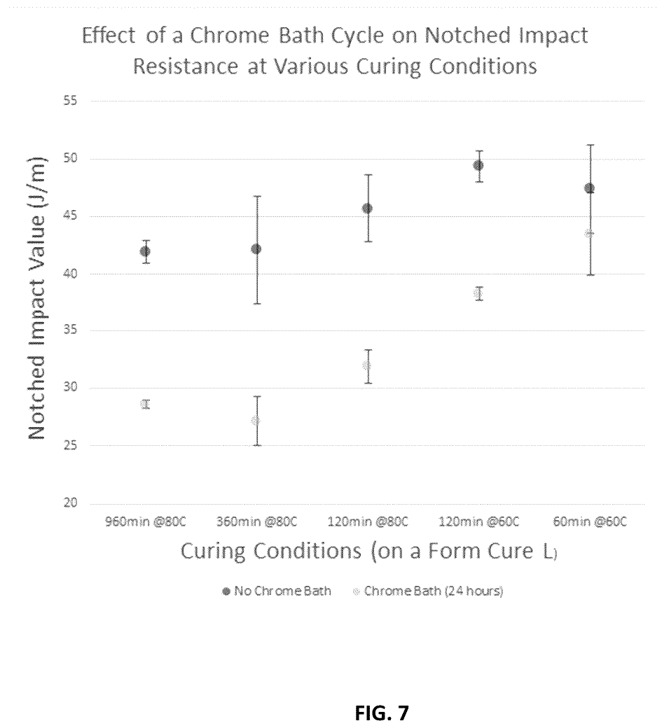

FIG. 7 illustrates the results of this experiment. In particular, FIG. 7 illustrates the effect of a chrome bath cycle on notched impact resistance at various curing conditions. It was discovered that, not only does curing time play a role in chemical resistance, but so does curing temperature. More temperature enables more molecular movement that allows for quicker crosslinking as well as quicker UV degradation if overexposed. Aside from the impact improvement shown in FIG. 7, the average weight changes immediately after the chrome bath and after fully drying are 0.153% and 0.047% respectively for the curing conditions of 60 minutes at 60° C., compared to the previous weight changes of 0.239% and 0.131% respectively for the curing conditions of 960 minutes at 80° C., which shows a significant improvement in weight change with the new curing conditions. These tests were done with standard notched impact parts of 12.70 mm thickness, 63.5 mm long, and 10 mm wide. ASTM approved notches were made into the parts before being submerged into the chrome baths.

As discussed herein, the use of polybutadienes in the resin formulation resulted in favorable mechanical and chemical properties for the final cured mask. For example, polybutadienes provide flexibility without sacrificing chemical resistance, which allows the formulation to be tougher than other “chemically resistant” resins in the prior art. In some example cases, the inventors considered toughness and chemical resistance to be maintaining an impact resistance of above 40 J/m, which does not appear in other chemically resistant resins.

Some possible polybutadienes include BR-643 (difunctional aliphatic polybutadiene urethane acrylate, available from Bomar®), BR-641E (polybutadiene urethane acrylate, available from Bomar®), polybutadiene urethane methacrylate, BR-640D (aliphatic polybutadiene urethane acrylate, available from Bomar®), aliphatic polybutadiene urethane methacrylate, aliphatic polybutadiene acrylate, aliphatic polybutadiene methacrylate, CN-310 (urethane acrylate, available from Sartomer®), CN-308 (acrylate ester, available from Sartomer®), polybutadiene acrylate, CN-307 (hydrophobic acrylate ester, available from Arkema®), CN-303 (polybutadiene dimethacrylate, available from Arkema®), and CN-301 (polybutadiene dimethacrylate, available from Arkema®). Each of the above multifunctional polybutadienes can be of the di or tri variation, or can otherwise be multifunctional.

The selection of polybutadienes resulted in great chemical resistance and low viscosity. It also added flexibility to the resin, which, in combination with the other components, enabled strong impact resistance without sacrificing chemical resistance. Polybutadienes also have a strong degree of hydrophobicity which prevents water intake, are compatible with other components more so than their alternatives, and can stand longer sun exposure times while maintaining original mechanical properties, which is a property that lacks with many other polybutadienes selected. The higher performing mechanical properties allow for a more liberal use of crosslinkers and diluents before the impact resistance is sacrificed.

The one or more selected crosslinkers are relatively compatible with the polybutadienes used and are specifically selected to ensure stronger green strength and final part rigidity while minimally sacrificing impact resistance of the parts, even at high crosslinker ratios. Chemical resistance of the crosslinkers was fair relative to the rest of the components and good relative to all photopolymers tested. The selected crosslinkers have a low swelling percentage which further enforces the overall chemical resistance of the hydrophobic polybutadienes.

Exemplary crosslinkers include BDT-4330 (30 functional thioether dendritic acrylate, available from Bomar®), XDT-1018 (18 functional thioether dendritic acrylate, available from Bomar®), any other multifunctional thioether dendritic acrylate, SR-606A (esterdiol diacrylate, available from Sartomer®), multifunctional esterdiol methacrylate, SR-454 (ethoxylated (3) trimethylolpropane triacrylate, available from Sartomer®), any other multifunctional ethoxylated trimethylolpropane acrylate, SR-351H (trimethylolpropane triacrylate, available from Sartomer®), any other multifunctional trimethylolpropane acrylate, multifunctional trimethylolpropane methacrylate, multifunctional ethoxylated bisphenol A methacrylate, SR-348 (ethoxylated (2) bisphenol A dimethacrylate, available from Sartomer®), any other multifunctional methoxylated bisphenol A acrylate, multifunctional hexanediol acrylate, multifunctional hexanediol methacrylate, SR-239 (1,6 hexanediol dimethacrylate, available from Sartomer®), and SR-238 (1,6-hexanediol diacrylate, available from Sartomer®). Each of the above multifunctional crosslinkers can be of the di or tri variation, or can otherwise be multifunctional.

The one or more selected diluents were highly chemically resistant, comparable to the polybutadienes used. Their rigid nature further reinforces the crosslinker's role of adding rigidity to the soft and flexible polybutadienes. Just like the crosslinkers, the diluents minimally reduce the impact resistance of the formulation even at higher ratios. Their high glass transition temperature enabled cured parts to withstand much higher temperatures than the polybutadienes alone without morphing out of shape. Their very low viscosity and diluting power enables the formulation to achieve the desired viscosity expectations even with relatively small ratios used. The diluents are highly compatible with both the polybutadienes and the crosslinkers.

Exemplary diluents include SR-506A (isobornyl acrylate, available from Sartomer®), SR-484 (octyldecyl acrylate, available from Sartomer®), octyldecyl methacrylate, isodecyl methacrylate, SR-423A (isobornyl methacrylate, available from Sartomer®), SR-395 (isodecyl acrylate, available from Sartomer®), SR-206 (ethylene glycol dimethacrylate, available from Sartomer®), SR-205 (triethylene glycol dimethacrylate, available from Sartomer®), glycol acrylate, glycol methacrylate, ethylene glycol acrylate, ethylene glycol methacrylate, Photomer 4028 (ethoxylated (4) bisphenol A diacrylate, available from IGM Resins®).

The above exemplary polybutadienes, crosslinkers, and diluents can be used as the polybutadienes, crosslinkers, and diluents above with respect to Tables 2 and 3. The use of proprietary brand names is not meant to be limiting and is intended for explanatory purposes only. Further detail is provided in the Examples below, which are intended for exemplary purposes only and are not meant to limit the scope of the invention.

### Example 1

| Component | Ratio (%) |
|---|---|
| Difunctional aliphatic polybutadiene urethane | 47 |
| acrylate oligomer (BR-643 as one example) | |
| Trimethylolpropane triacrylate (SR-351H as | 5 |
| one example) | |
| Dendritic multifunctional oligomer (BDT- | 5 |
| 4330 as one example) | |
| Isobornyl acrylate (SR-506A as one example) | 31 |
| Isodecyl acrylate (SR-395 as one example) | 12 |
| Ethyl phenyl(2,4,6- | 0.5 |
| trimethylbenzoyl)phosphinate | |
| 2,5-Bis(5-tert-butyl-2-benzoxazolyl)thiophene | 0.05 |

This example provided a good starting point for further analysis. The chemical resistance was adequate but not ideal. Color staining was almost nonexistent. But the samples showed weak impact resistance prior to chemical baths compared to the desired goal (the example showed impact resistance of 27 J/m while the desired goal was 40 J/m or more). Ratio iterations were tested and with varying crosslinker ratios and polybutadiene ratios, but chemical resistance improvements were not substantial. Ratios of polybutadiene above about 55-65% led to large increases in viscosity well above the ideal printing conditions.

### Example 2

| Component | Ratio (%) |
|---|---|
| Polybutadiene urethane acrylate oligomer | 40 |
| (BR-641E) | |
| Octyldecyl acrylate (SR-484) | 30 |
| Ethoxylated trimethylolpropane triacrylate | 5 |
| (SR-454) | |
| Difunctional acrylic monomer (SR-238) | 25 |
| 2,5-Bis(5-tert-butyl-2-benzoxazolyl) | 0.04 |
| thiophene | |
| Ethyl phenyl(2,4,6- | 0.4 |
| trimethylbenzoyl)phosphinate | |
| Isopropylthioxanthone | 0.1 |

This Example showed improved results. Impact strength tested after one cycle of chrome bath resulted in an impact strength still above the desired 40 J/m. After three cycles, however, cracks began forming on the surface of the parts, indicating a loss of polymer. Impact strength dropped below 20 J/m indicating undesired impact strength. Chemical resistance had mixed results. Weight change after one cycle exposure of chrome was high (greater than 1%). Color staining after chrome bath was also significant. Further changes in the ratios of the mask components led to slightly improved chrome bath cycle resistance and color post chrome bath. The highest percentage of polybutadiene was 70% before viscosity issues began to form. Attempts at minimizing the polybutadiene content for flexural functionality resulted in improved color and absorption in this formulation. The minimum polybutadiene content that allowed for the desired impact strength was 35% with adjusted crosslinker and diluents. Samples that were lower than that amount would not maintain the desired impact strength prior to chrome bath.

### Example 3

| Component | Ratio (%) |
|---|---|
| Urethane acrylate oligomer (CN-310) | 26 |
| Acrylate ester oligomer (CN-308) | 25 |
| Isobornyl methacrylate (SR-423A) | 38 |
| Ethoxylated (2) bisphenol A dimethacrylate | 11 |
| (SR-348) | |
| 2,5-Bis(5-tert-butyl-2-benzoxazolyl) | 0.04 |
| thiophene | |
| Phenyl-bis(2,4,6-trimethyl benzoyl) | 1 |
| phosphine oxide | |
| 4-hydroxy-2,2,6,6-tetramethylpiperidin-1- | 0.01 |
| oxyl | |

The above example provided improved color from previous formulation, but not as well as Example 1. Chemical resistance was moderate. Repeated baths did not lead to noticeable surface cracking as Example 2 showed, yet still had a more than desired shift of impact properties over multiple chrome bath cycles. The ethoxylated (2) bisphenol A dimethacrylate (SR-348) component was a good crosslinker but had limited compatibility with most polybutadienes used. In this formulation, chemical resistance suffered when decreasing the diluent and crosslinker ratio. A noticeable increase in chemical and mechanical properties was observed at larger diluent and crosslinker values. Although this would be an improvement, the limited compatibility of SR-348 requires larger quantities of diluent for a stable formulation. It was seen that values higher than 40-50% of smaller monomers used in the testing (diluents and crosslinkers included) often caused swelling and quick damage to the printer's nonstick films. The exact threshold was dependent on the formulation and the diluent and crosslinkers used. In this formulation, this phenomenon limited the improvement of the mechanical and chemical properties of the final parts.

The percentages discussed above are weight percentages of the overall composition of the resin. Based on the above experimental results, the present inventors discovered the percentages of the components to be 35-70% by weight polybutadienes, 10-50% by weight diluents, and 10-50% by weight crosslinkers.

The present inventors found more particular ranges to provide even better unexpected results. For polybutadienes: an upper limit of less than 70%, preferably less than 60%, more preferably less than 50%. For a lower limit, greater than 35%, preferably greater than 39%, more preferably greater than 42%.

For dilutents: an upper limit of less than 50%, preferably less than 40%, more preferably less than 35%, most preferably less than 30%. For a lower limit, greater than 10%, preferably greater than 15%, most preferably greater than 20%.

For crosslinkers: an upper limit of less than 50%, preferably less than 40%, more preferably less than 35%. For a lower limit, greater than 10%, preferably greater than 20%, more preferably greater than 25%.

In one set of examples, the present inventors found a range for polybutadiene between 42-50%, a range for diluents between 20-30%, and a range for crosslinker between 25-35%. Again, these percentages are for weight percent. The examples provided are not meant to be limiting and are provided for explanatory purposes only.

Through experimentation, the above Examples unexpectedly illustrated that levels lower than 35% polybutadiene resulted in a lack of part flexibility causing low impact resistance even with minimal to no crosslinker addition. The degree of brittleness was dependent on the selection and ratio of crosslinkers and monomers used to dilute, as well as the polybutadiene selection. The curing conditions also played a role on the final impact strength of the part. In general, higher functionality crosslinkers caused brittleness to occur even at higher polybutadiene ratios, while eliminating crosslinkers fully allowed brittleness to occur at lower polybutadiene levels but led to other complications mentioned below. Less flexible polybutadienes (such as CN-308, for example) achieved undesired brittleness at higher percentages as compared to a more flexible polybutadiene (such as BR 641E).

On the other hand, a viscosity limitation limited the upper percentage range of polybutadiene addition, which was also not expected. Stronger diluters such as isobornyl acrylate expanded the upper limit, whereas larger amounts of a more viscous crosslinker such as SR-348 decreased the upper limit. The polybutadiene selection played a major role on this upper limit as well, since less viscous polybutadienes required less diluting to achieve an acceptable viscosity for printing. The goal was a viscosity below 1000 cP, because above that viscosity would dramatically increase the suction forces on the vat and decrease the resin migration speed, both leading to less reliably successful prints. With the workable formulations, this upper limit was about 70% polybutadiene using strong diluters and lower viscosity polybutadienes.

Lower molecular weight diluting acrylates (diluents) were used to lower the viscosity of the final formulation and to serve as “solvents” for other components inside the formulation. In higher concentrations, these lower molecular weight components can leech into the vat film and cause swelling and vat damage. This is dependent on the compatibility of the vat films with the individual components and their concentrations in the formula. The selected screened components had partial compatibility, meaning that low enough percentages would not lead to any substantial vat damage with considerable long-term exposure. 50% diluent was the observed upper limit before vat damage was witnessed with most formulation combinations. On the other hand, enough diluent was required in the formulation for various reasons. The first reason was to decrease the viscosity of the resin. The second reason was to increase the overall compatibility between some of the polybutadienes and the crosslinkers. Some combinations of the polybutadienes and crosslinkers were only partially compatible and thus either did not mix in all ratios or did not mix well at all without the addition of a diluting acrylate. Higher levels of diluent components typically led to increased compatibility between the partially compatible polybutadienes and crosslinkers, serving essentially as solvents. The minimum required diluents depended on the initial compatibility of the polybutadiene(s) and crosslinker(s). The type of diluent used also played a role in compatibility, as some diluents behaved as better binding solvents to certain polybutadiene/crosslinker combinations. In general, formulas below 10% diluent led either to viscosity or compatibility issues.

Crosslinker ratio limits were tied to diluent ratios. Both diluents and crosslinkers served the purpose of decreasing the overall viscosity, only that the selected crosslinkers did this less efficiently than the selected diluents. Both diluents and crosslinkers served the purpose of adding rigidity to the formulation, but due to the generally higher reactivity and acrylate functionality, the selected crosslinkers added a much higher crosslinking density to the formulation compared to diluents, even at relatively low values. This increase in crosslinking density helped create a tighter polymer matrix, thus helping prevent water absorption and increasing overall chemical resistance. The selected crosslinkers had better overall compatibility with the vat film. When too little crosslinker was used, chemical resistance suffered after multiple chrome bath cycles, as various sections of the polymer matrix were not covalently bonded which allowed the hot acidic bath conditions to detangle and deteriorate the polymer matrix at a quicker rate. When a higher crosslinker ratio was used, the inventors observed less color penetration after one cycle, indicating that due to less chemical penetration, only the surface of the parts could be attacked to any capacity. (See FIG. 4 for visual of color penetration). Due to the more reactive nature of the crosslinkers, lower crosslinker ratios also led to printing complications, as the green strength of the parts was dependent on the fast-curing crosslinkers. Lower crosslinker ratios inevitably meant more diluent and/or polybutadiene ratios, which caused other issues discussed above. This lower limit for the crosslinker was therefore approximately 10%, the same as the diluents, as they were codependent on each other. With some higher functionality, highly reactive crosslinkers, such as SR-351H or BDT-4330 for example, could be used and still avoid the undesired complications. With these crosslinkers, the issue arises when higher ratios are used. When the ratio of crosslinkers is too high, compatibility with the polybutadienes becomes a larger problem, partially since more crosslinker usually means less diluent is being used to maintain a proper polybutadiene ratio. Once again, this compatibility issue is highly reliant on the selected polybutadiene and crosslinker.

Another issue that occurred from higher crosslinker percentages was a quick rise in brittleness, which was observed with crosslinkers at a much lower ratio than diluents. This issue became more amplified with higher functionality crosslinkers but varied greatly between crosslinkers. While some crosslinkers such as SR-606A can be in larger ratios as high as 45-50% while still adding toughness to the formulation, other crosslinkers such as XDT-1018 can only reach ratios of about 10-15% at most before significant brittleness is seen. However, in the best cases with a highly compatible polybutadiene/crosslinker ratio and a tougher, lower functional crosslinker, the maximum ratio of crosslinker that can be used was 50% before the above issues were observed.

The amount of crosslinker and diluent, as well as polybutadiene that can be used, depended on the overall ratio. Formulations can afford more diluent in terms of brittleness when less crosslinker is used, and vice versa. The goals of the formula were to achieve a stable formula, low viscosity (below 1000 cP), minimal to no vat damage (compatible with the vats), reliable printing, tough formulation (impact strength above 40 J/m), and chemically resistant after testing in chrome baths (e.g., low weight change after 24 hr bath cycles) as well as mechanically proficient after testing in chrome baths (e.g., impact strength above 40 J/m).

Below are results from a composition falling within the ranges set forth above. The resin had a shelf life and pot life of at least six months and two months respectively. Following the post printing, washing, and curing steps, the parts had an average notched impact of 44.1 J/m following ASTM D256 standards. Tensile and flexural modulus were an average of 0.56 and 0.49 GPa following ASTM D638 and ASTM D790 respectively. The sample had: (1) an average tensile elongation at break of 38.2% following ASTM D638; (2) an average tensile and flexural strength of 14.9 MPa and 17.4 MPa following ASTM D638 and ASTM D790, respectively; (3) an average shore hardness of 68D following ASTM D2240; (4) a viscosity of about 840 cP at 25° C. and 424 cP at 35° C. following ASTM D4287; (5) a glass transition temperature of 65° C. following ASTM E831; and (6) a volume resistivity of 1.2×10¹⁶ ohm-cm following ASTM D257.

A layout of the mechanical properties can be seen on table 8 below.

TABLE 8
Mechanical properties of representative sample

| | | |
|---|---|---|
| TEST | RESULT | METHOD |

Tensile Properties

| | | | |
|---|---|---|---|
| Ultimate Tensile Strength | 14.9 | MPa | ASTM D638 |
| Young's Modulus | 0.56 | GPa | ASTM D638 |

| | | |
|---|---|---|
| Elongation at Break | 38.2% | ASTM D638 |

Flexural Properties

| | | | |
|---|---|---|---|
| Flexural Strength | 17.4 | MPa | ASTM D790-15 |
| Flexural Modulus | 0.49 | GPa | ASTM D790-15 |

Impact Properties

| | | | |
|---|---|---|---|
| Notched Izod | 44.1 | gm | ASTM D256-10 |

Physical Properties

| Shore Hardness | 68D | | ASTM D2240 |
|---|---|---|---|
| Density (Solid) | 1.07 | g/mL | ASTM D792-20 |
| Glass Transition Temperature | 65° | C. | ASTM E831 |
| CTE (below Tg) | 135.8 | μm/m · ° C. | ASTM E831 |
| Volume Resistivity | 1.2.10¹⁶ | ohm-cm | ASTM D257 |
| Viscosity (25° C.) | 840 | cP | ASTM D4287 |
| Viscosity (35° C.) | 424 | cP | ASTM D4287 |

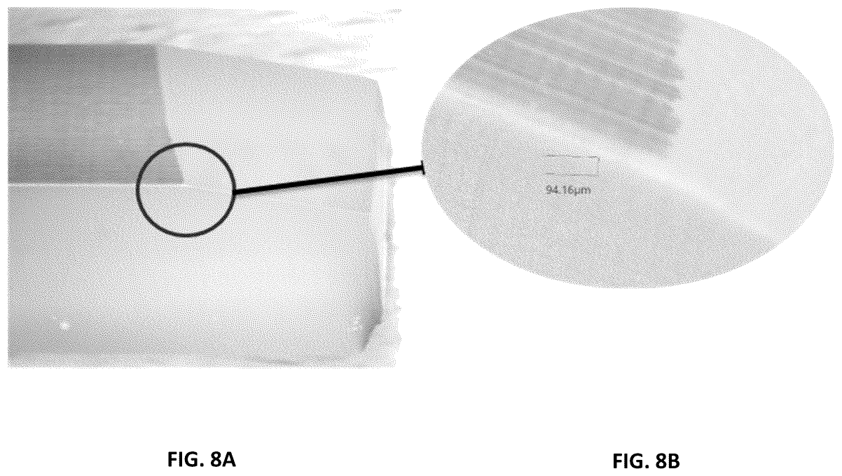

Using 1×1×1 cm sample cubes, the weight change was recorded to be less than 0.25% post bath and less than 0.1% after fully drying. Larger cubes showed less overall weight changes, indicating that weight change is only occurring on the surface of the parts. Further confirmation of this is seen in FIGS. 8A and 8B, which illustrate surface staining only.

For various other bath solutions, the weight change did not exceed 0.1% post bath after a 24 hour soak. The following meet that criteria: acetic acid 5% (room temperature), anodize (e.g., Boeing® BAC 5022), hard anodize (e.g., Boeing® BAC 5821), copper plating (MIL-C-14550), nickel plating (e.g., Pratt® PS321, PS324), Rochelle salts (e.g., Boeing® BAC 5771), sulfuric acid etch (30%, Ambient®). Various other solutions did not exceed 0.15% post bath after a 24 hour soak. The following meet that criteria: Alkaline Derust (e.g., 20% NaOH, 65° C.), passivate nitric acid (AMS 2700), and salt water (3.5% NaCl).

A layout of the chemical properties can be seen on Table 9 below.

TABLE 9
Chemical properties based on bath solution

| | | 24 h |
|---|---|---|
| Solution | Specification | weight gain |
| Acetic Acid 5% | 5% | 0.08% |
| Anodize | Boeing BAC 5022 | 0.05% |
| Hard Anodize | Boeing BAC 5821 | 0.05% |
| Alkaline Derust | 20% NaOH, 65° C. | −0.12% |
| Chrome Etch | Pratt PS116, C-305 | 0.13% |
| Chrome Plating | MIL-STD-1501, 54° C. | 0.13% |
| Copper Plating | MIL-C-14550 | 0.03% |
| Isopropyl Alcohol | 90% | 2.48% |
| Nickel Plating | Pratt PS321, PS324 | 0.07% |
| Nitric Acid Strip | Boeing BAC 5771 | 0.49% |
| Passivate (Nitric Acid) | AMS 2700 | 0.11% |
| Rochelle Salts | Boeing BAC 5771 | 0.03% |
| Salt Water | 3.5% NaCI | 0.12% |
| Sulfuric Acid Etch | 30%, Ambient | 0.01% |
| Water | | 0.16% |

Notched impact results for parts submerged in chrome baths for one 24-hour cycle showed little to no change compared to parts not treated in the baths (above 40 J/m).

The following discusses post-processing of the disclosed sample. Previously, to avoid tackiness on the surface of printed parts, the inventors would post-cure the parts submerged in distilled water to prevent oxygen inhibition on the surface. It was discovered that the main reason for this tackiness was due to improper washing of the printed parts. Due to the hydrophobic nature of resin, traditional solvents used to wash photocurable resins, such as isopropyl alcohol and tripropylene glycol monomethyl, do not work very well. Instead, the inventors tested other solvents that were more nonpolar which could remove the uncured resin from the surface more efficiently. After testing many solvents and qualitatively analyzing their effectiveness to remove tackiness and sheen from the printed parts, it was concluded that odorless mineral spirits were a sufficient solvent choice for this resin. Odorless mineral spirits have relatively low flash points and low odor. They can easily be purchased at most home improvement retailer stores and they can fully wash parts in as quickly as 5 minutes.

As is known in the art, additive manufacturing involves the solidification of a three-dimensional object. This solidification can come in many forms, e.g., can be a layer by layer solidification based on the input of data into the additive manufacturing machine. For example, a user can input data into an additive manufacturing machine that describes the three-dimensional geometry of the object to be solidified, and the additive manufacturing machine will then solidify the object, layer by layer, by vertically moving a build area by a distance corresponding to a thickness of the layer. This solidification can come in the form of UV light, a laser, or any other form of curing, sintering, melting, or hardening of a material. In some embodiments, an additive manufacturing machine is not necessary and additive manufacturing can be implemented by spraying the material onto the surface of the object to be masked.

Any additive manufacturing technique can be implemented according to the present disclosure. In some embodiments, the disclosed resin is additively manufactured using stereolithography (SLA) or digital light processing (DLP) techniques, or any other form of UV or other light-curable technique. In other examples, the material can be formed into a powder and the three-dimensional object can be created using powder bed fusion, or the material may be cured via vat photopolymerization, or solidified via material jetting, or any other form of creating a three-dimensional object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A method comprising:
providing a resin comprising one or more polybutadienes, one or more diluents, and one or more crosslinkers;
printing a mask made of the resin through additive manufacturing techniques;
applying the mask onto a target surface of an object; and
submerging the object in a chemical bath.

2. The method of claim 1, wherein the polybutadienes are at least one member selected from the group consisting of difunctional aliphatic polybutadiene urethane acrylate, polybutadiene urethane acrylate, polybutadiene urethane methacrylate, aliphatic polybutadiene urethane acrylate, aliphatic polybutadiene urethane methacrylate, aliphatic polybutadiene acrylate, aliphatic polybutadiene methacrylate, urethane acrylate, acrylate ester, polybutadiene acrylate, hydrophobic acrylate ester, polybutadiene dimethacrylate, and polybutadiene dimethacrylate.

3. The method of claim 1, wherein the diluents are at least one member selected from the group consisting of isobornyl acrylate, octyldecyl acrylate, octyldecyl methacrylate, isodecyl methacrylate, isobornyl methacrylate, isodecyl acrylate, ethylene glycol dimethacrylate, triethylene glycol dimethacrylate, glycol acrylate, glycol methacrylate, ethylene glycol acrylate, ethylene glycol methacrylate, and ethoxylated (4) bisphenol A diacrylate.

4. The method of claim 1, wherein the crosslinkers are at least one member from the group consisting of 30 functional thioether dendritic acrylate, 18 functional thioether dendritic acrylate, multifunctional thioether dendritic acrylate, esterdiol diacrylate, multifunctional esterdiol methacrylate, ethoxylated (3) trimethylolpropane triacrylate, multifunctional ethoxylated trimethylolpropane acrylate, trimethylolpropane triacrylate, multifunctional trimethylolpropane acrylate, multifunctional trimethylolpropane methacrylate, multifunctional ethoxylated bisphenol A methacrylate, ethoxylated (2) bisphenol A dimethacrylate, multifunctional methoxylated bisphenol A acrylate, multifunctional hexanediol acrylate, multifunctional hexanediol methacrylate, 1,6 hexanediol dimethacrylate, and 1,6-hexanediol diacrylate.

5. The method of claim 1, wherein the polybutadienes are present in a range of 20-80% by weight, the diluents are present in a range of 10-50% by weight, and the crosslinkers are present in a range of 10-50% by weight, of a weight of the resin.

6. The method of claim 1, wherein the step of printing the mask includes solidifying the resin using stereolithography (SLA).

7. The method of claim 1, wherein the step of printing the mask includes solidifying the resin using digital light processing (DLP).

8. A method comprising:
combining one or more polybutadienes, one or more diluents, and one or more crosslinkers into a composition;
inputting data indicating a three-dimensional geometry of a mask into an additive manufacturing machine;
solidifying the composition, layer by layer, using the additive manufacturing machine, thereby forming the mask;
applying the mask to an object; and
submerging the object in a chemical bath.

9. The method of claim 8, wherein the polybutadienes are at least one member selected from the group consisting of difunctional aliphatic polybutadiene urethane acrylate, polybutadiene urethane acrylate, polybutadiene urethane methacrylate, aliphatic polybutadiene urethane acrylate, aliphatic polybutadiene urethane methacrylate, aliphatic polybutadiene acrylate, aliphatic polybutadiene methacrylate, urethane acrylate, acrylate ester, polybutadiene acrylate, hydrophobic acrylate ester, polybutadiene dimethacrylate, and polybutadiene dimethacrylate.

10. The method of claim 8, wherein the diluents are at least one member selected from the group consisting of isobornyl acrylate, octyldecyl acrylate, octyldecyl methacrylate, isodecyl methacrylate, isobornyl methacrylate, isodecyl acrylate, ethylene glycol dimethacrylate, triethylene glycol dimethacrylate, glycol acrylate, glycol methacrylate, ethylene glycol acrylate, ethylene glycol methacrylate, and ethoxylated (4) bisphenol A diacrylate.

11. The method of claim 8, wherein the crosslinkers are at least one member from the group consisting of 30 functional thioether dendritic acrylate, 18 functional thioether dendritic acrylate, multifunctional thioether dendritic acrylate, esterdiol diacrylate, multifunctional esterdiol methacrylate, ethoxylated (3) trimethylolpropane triacrylate, multifunctional ethoxylated trimethylolpropane acrylate, trimethylolpropane triacrylate, multifunctional trimethylolpropane acrylate, multifunctional trimethylolpropane methacrylate, multifunctional ethoxylated bisphenol A methacrylate, ethoxylated (2) bisphenol A dimethacrylate, multifunctional methoxylated bisphenol A acrylate, multifunctional hexanediol acrylate, multifunctional hexanediol methacrylate, 1,6 hexanediol dimethacrylate, and 1,6-hexanediol diacrylate.

12. The method of claim 8, wherein the polybutadienes are present in a range of 20-80% by weight, the diluents are present in a range of 10-50% by weight, and the crosslinkers are present in a range of 10-50% by weight, of the composition.

13. The method of claim 8, wherein the step of solidifying the composition includes solidifying the composition using stereolithography (SLA).

14. The method of claim 8, wherein the step of solidifying the composition includes solidifying the composition using digital light processing (DLP).

15. The method of claim 8, wherein the chemical bath is an electrochemical plating bath.

16. A mask for use in chemical applications, the mask comprising:
one or more polybutadienes in a range of 20-80% by weight;
one or more diluents in a range of 10-50% by weight; and
one or more crosslinkers in a range of 10-50% by weight.

17. The mask of claim 16, wherein the polybutadienes are at least one member selected from the group consisting of difunctional aliphatic polybutadiene urethane acrylate, polybutadiene urethane acrylate, polybutadiene urethane methacrylate, aliphatic polybutadiene urethane acrylate, aliphatic polybutadiene urethane methacrylate, aliphatic polybutadiene acrylate, aliphatic polybutadiene methacrylate, urethane acrylate, acrylate ester, polybutadiene acrylate, hydrophobic acrylate ester, polybutadiene dimethacrylate, and polybutadiene dimethacrylate.

18. The mask of claim 16, wherein the diluents are at least one member selected from the group consisting of isobornyl acrylate, octyldecyl acrylate, octyldecyl methacrylate, isodecyl methacrylate, isobornyl methacrylate, isodecyl acrylate, ethylene glycol dimethacrylate, triethylene glycol dimethacrylate, glycol acrylate, glycol methacrylate, ethylene glycol acrylate, ethylene glycol methacrylate, and ethoxylated (4) bisphenol A diacrylate.

19. The mask of claim 17, wherein the crosslinkers are at least one member from the group consisting of 30 functional thioether dendritic acrylate, 18 functional thioether dendritic acrylate, multifunctional thioether dendritic acrylate, esterdiol diacrylate, multifunctional esterdiol methacrylate, ethoxylated (3) trimethylolpropane triacrylate, multifunctional ethoxylated trimethylolpropane acrylate, trimethylolpropane triacrylate, multifunctional trimethylolpropane acrylate, multifunctional trimethylolpropane methacrylate, multifunctional ethoxylated bisphenol A methacrylate, ethoxylated (2) bisphenol A dimethacrylate, multifunctional methoxylated bisphenol A acrylate, multifunctional hexanediol acrylate, multifunctional hexanediol methacrylate, 1,6 hexanediol dimethacrylate, and 1,6-hexanediol diacrylate.

20. The mask of claim 17, wherein the mask is solidified via photocuring.
